(19) United States
(12) Patent Application Publication
(10) Pub. No.: US 2026/0208465 A1
(43) Pub. Date: Jul. 23, 2026

(54) THERMAL INSULATION DEVICE

(71) Applicant: Aerogel R&D PTE LTD., Chinatown Point (SG)

(72) Inventors: Jong Chul PARK, Daejeon (KR); Hua Ye EYO, Malaysian (MY); Wen Xi ZHANG, Chinatown Point (SG); Sivasangari MUTHURAMAN, Chinatown Point (SG)

(21) Appl. No.: 19/139,174

(22) PCT Filed: Dec. 15, 2023
(86) PCT No.: PCT/SG2023/050836

§ 371 Date: Jun. 13, 2025

(30) Foreign Application Priority Data
Dec. 16, 2022 (SG) 10202260465W

(51) Int. Cl. B32B 3/26; A62C 2/06; B32B 5/02; B32B 5/16; B32B 5/30; B32B 7/06; B32B 7/12; B32B 27/12; H01M 10/658

(52) U.S. Cl. CPC B32B 3/266; A62C 2/065; B32B 5/022; B32B 5/024; B32B 5/16; B32B 5/30; B32B 7/06; B32B 7/12; B32B 27/12; H01M 10/658; B32B 2250/05; B32B 2255/02; B32B 2255/20; B32B 2255/26; B32B 2260/021; B32B 2260/046; B32B 2262/101; B32B 2264/1021; B32B 2264/1022; B32B 2264/1023; B32B 2307/206; B32B 2307/304; B32B 2307/3065; B32B 2457/10

(57) ABSTRACT

A thermal insulation device comprising functional fillers enclosed in a bag. The bag is made of a film material comprising at least: an inorganic fiber layer; and a polymer layer, wherein the inorganic fiber layer is layered over the polymer layer. The bag comprises sealed sides formed by sealing the film material. The functional fillers are enclosed in the bag such that the functional fillers do not escape through the sealed sides of the bag. The functional fillers comprise thermal insulation particles in powder form.

### FIELD

The present invention relates to framed or unframed Thermal insulation devices/products. One or more fire retardant sheet and/or coating may be added to the insulation device to further enhance its capabilities. The insulation devices/products may be used in a battery, for instance, a battery of an Electric Vehicle.

### BACKGROUND

Existing thermal insulation devices containing aerogel as its core material and used in a battery is typically made with an aerogel blanket. An aerogel blanket is comprised of a non-woven matrix that acts as a reinforcement material for the aerogel with widespread use in the energy infrastructure market. An aerogel blanket's characteristics make it ideal for use as thermal insulation device for process lines due its unique ability to combat corrosion under insulation (CUI), it is less than ideal for use in batteries, especially in Battery Electric Vehicles. The non-woven matrix of the aerogel blanket can impact thermal insulation performance and mechanical properties, especially under very high compression that can damage the inorganic fibers and alter the compression characteristics of the aerogel blanket.

### SUMMARY

According to an example of the present disclosure, there is provided a Thermal insulation device as claimed in the independent claim and a battery comprising the claimed Thermal insulation device. Some optional features are defined in the dependent claims.

### BRIEF DESCRIPTION OF THE DRAWINGS

Examples in the present disclosure will be better understood and readily apparent to one skilled in the art from the following written description, by way of example only and in conjunction with the drawings, in which:

FIG. 1 shows a Thermal insulation device according to an example of the present disclosure.

FIG. 2 shows a Thermal insulation device according to another example of the present disclosure.

FIGS. 3a-b show film structures of Thermal insulation devices according to examples of the present disclosure.

FIG. 4 shows a film material layer according to an example of the present disclosure.

FIGS. 5a-b shows a bag with 4 sealed sides of a Thermal insulation device according to an example of the present disclosure.

FIG. 6 shows a bottom view and a top view of a bag with 3 sealed sides of a Thermal insulation device according to an example of the present disclosure.

FIG. 7a shows an example of a bag of a Thermal insulation device according to an example of the present disclosure that is subjected to pre-flapping (corner folding).

FIG. 7b shows a front view of a pre-flapped (corner folded) bag according to an example of the present disclosure.

FIGS. 8a-b show flapping of a bag of a Thermal insulation device according to an example of the present disclosure.

FIGS. 9a-d show examples of tape or adhesive applied to a Thermal insulation device.

FIGS. 10a-c show examples of compositions comprising a combination of a Thermal insulation device according to an example of the present disclosure, Fire-Retardant devices and/or intumescent sheet/coating.

FIGS. 11a-b show steps to frame and seal a bag of a Thermal insulation device according to an example of the present disclosure.

FIGS. 12a-b show a Framed Thermal insulation device according to an example of the present disclosure.

FIGS. 13a-b show yet another Framed Thermal insulation device according to an example of the present disclosure.

FIG. 14 shows possible dimensions of the examples of the Framed Thermal insulation device of FIGS. 12a-b and FIGS. 13a-b.

FIG. 15 shows front, rear and side views of a first example of a Thermal insulation device according to an example of the present disclosure with flapped or folded seals.

FIG. 15a shows a front, rear and side views of a second example of a Thermal insulation device according to an example of the present disclosure with flapped or folded seals.

FIG. 15b shows a front, rear and side views of a third example of a Thermal insulation device according to an example of the present disclosure with flapped or folded seals.

FIG. 15c shows a front, rear and side views of a fourth example of a Thermal insulation device according to an example of the present disclosure with flapped or folded seals.

FIG. 16 shows a graph of weight vs. temperature for an E-Glass Fiber sample.

FIG. 17 shows a graph of mass % vs. temperature for a thermal insulation device having the film structure of PET/EG/PE.

FIG. 18 shows a table comparing performance data between thermal insulation devices having the film structures of PET/EG/PE and PET/AL/PE respectively.

### DESCRIPTION

In the present disclosure, an Electric Vehicle (EV) refers to a vehicle that uses one or more electric motors for propulsion and is typically powered by a battery. Such EV is also known as a Battery Electric Vehicle (BEV). EVs include but are not limited to, road and rail vehicles (e.g. electric scooters, electric bicycles, electric cars, space exploration vehicles, etc.), surface and underwater vessels, electric aircraft (e.g. manned/unmanned planes and air-drones etc.), and electric spacecraft.

In the present disclosure, there is provided a Thermal insulation device with compressible heat shields containing for example, aerogel suitable for, but not limited to, use in a battery suitable for Electric Vehicle (EV). The Thermal insulation device is relatively lightweight in the context of its application in a battery of an Electric Vehicle. The term “Thermal insulation device” refers to said Thermal insulation device throughout the present disclosure.

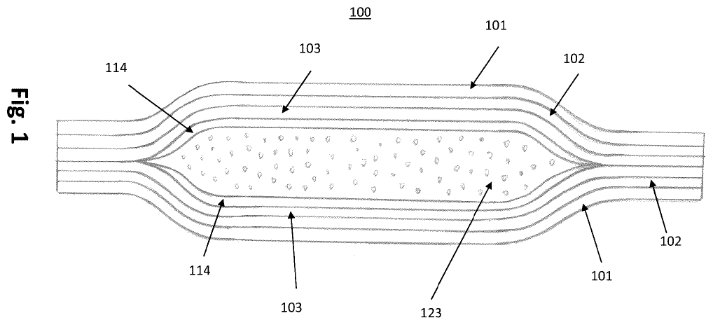

One example of the Thermal insulation device 100 is shown in FIG. 1. The Thermal insulation device is a bag (or sachet or packet or package or pouch or container) filled with aerogel sealed into a “blade” structure. The bag 100 includes three film material layers FML1 101, FML2 102 and FML3 103, with the film material layer FML1 101 being a cover layer, the film material layer FML3 103 being an inner layer, the film material layer FML2 102 being disposed between the film material layers FML1 101 and FML3 103. The film material layer FML1 101 is optional and can serve to protect the insulation device from an external environment. The film material layer FML2 102 blocks heat and fire and provides mechanical strength as a reinforcement layer of the insulation device 100. The film material layer FML3 103 serves to maintain the shape of the insulation device 100. In one example, the film material layer FML3 may also improve the insulation performance of the insulation device 100 and form an internal structure capable of maintaining a uniformly distributed state of the functional filler. There may be perforations (or holes or micro-perforations or pores or openings or orifices, not shown) in the film material layers. The average diameter of the perforations (or holes or pores or openings or orifices) may be 15 μm or less. In another example, the film material layer FML3 and/or other layer or layers may have a characteristic that when it is heated and cooled to shape during a heating and cooling step to be described later (see step (17) of an example of a manufacturing process of the Thermal insulation device), the perforations are sealed. Sides of the film material layers are sealed to form the bag 100 which may contain a functional filler therein. The functional filler may include essentially thermal insulation particles. The term “film material” is used interchangeably with “film structure” in the present disclosure.

For example, a first functional filler FF1 may include at least one of an aerogel powder, a fumed silica and glass bubbles. The aerogel powder includes fine particles of silica (SiO₂) with diameters 100 μm or lower. FF1 are thermal insulation particles in powder form.

A second functional filler FF2 may include at least one of titanium dioxide (TiO₂), iron oxide (Fe₂O₃), and aluminum oxide (Al₂O₃). It serves to improve the insulation performance by suppressing the increase in thermal conductivity of the insulation device even in a high temperature environment.

A third functional filler FF3 may include at least one of magnesium hydroxide (MDH), aluminium hydroxide (ATH), and zinc borate. When placed in an EV battery and a fire occurs in the battery pack, the functional filler 3 can be decomposed during the combustion process to release water and non-combustible gases such as nitrogen, ammonia, or carbon dioxide, thereby cooling and diluting oxygen, and simultaneously producing water, which may delay the fire.

In one example, FF1 is a key component, whereas FF2 and FF3 are optional. They have to be mixed uniformly or homogeneously prior to filling into the bag of the Thermal insulation device 100.

A fourth functional filler FF4 114 may be a reinforcement fiber that encloses the functional fillers FF1, FF2 and FF3 123 therein and is adjacent to the film material layer FML3 103. The functional filler FF4 114 includes at least one of glass fiber, a silica wool, a mineral wool, a ceramic wool, a woven fiber, and a non-woven fiber. FF4 may also be a glass fiber veil bound by acrylic resin, which can be a continuous filament glass fiber product. FF4 114 is an optional layer. FF4 114 can be said to be an innermost layer in the present disclosure because it contacts FF1, FF2 and/or FF3. If FF4 114 is not present, FML3 103 will be such innermost layer.

A table 1 below shows examples of the composition of the Thermal insulation device.

TABLE 1

| | |
|---|---|
| Functional Filler | About 0.1 to 0.3 g/cm³ |
| Density | |
| Functional Filler FF1 | About 50-100 weight % (wt %) [at least one of aerogel powder, fumed |
| | silica, and glass bubbles] |
| Functional Filler FF2 | About 1-20 wt % [at least one of titanium dioxide (TiO₂), iron oxide |
| | (Fe₂O₃), and aluminum oxide (Al₂O₃)] |
| Functional Filler FF3 | About 1-20 wt % [at least one of magnesium hydroxide (MDH), |
| | aluminium hydroxide (ATH), zinc borate, aluminium polyphosphate, |
| | and melamine cyanurate] |
| Functional Filler FF4 - | About 0.1-2 mm thick and density about 30 g/m2 to 200 g/m2 [at |
| This can be an | least one of glass fiber, a silica wool, a mineral wool, a |
| inorganic fiber layer. | ceramic wool, a woven fiber, and a non- woven fabric fiber] |
| | FF4 can also be a glass fiber veil bound by acrylic resin. |
| Film Material Layer | About 10-50 μm thick Polymer film [e.g. at least one of |
| FML1 - This is a cover | polycarbonate (PC), polyimide (PI) film, a polyethylene |
| layer and can be an | terephthalate (PET) film, a cyclic olefin polymer (COP) film, |
| inorganic fiber layer | a casting polypropylene (CPP) film, and a nylon film |
| or polymer layer too. | Or |
| | About 10-190 μm thick Woven ceramic fiber or Woven inorganic |
| | fiber e.g. E-glass (EG, nominal weight about 10 g/m² to 200 g/m²)] |
| Film Material Layer | About 10-190 μm thick, Woven ceramic fiber or Woven inorganic |
| FML2 - This can be an | fiber e.g. E-Glass (EG, nominal weight about 10 g/m² to 200 g/m²)] Or |
| inorganic fiber layer | about 10-50 μm thick, at least one of Aluminum and mica |
| or polymer layer. | Or |
| | About 50-100 μm thick flame retardant thermoplastic composite |
| | where polymers include polycarbonate (PC), and at least one of |
| | polyimide (PI) film, a polyethylene terephthalate (PET) film, |
| | a cyclic olefin polymer (COP) film, a casting polypropylene (CPP) |
| | film, and a nylon film |
| Film Material Layer | About 50-150 μm thick polymer [polycarbonate (PC), Polyethylene |
| FML3 - This is a | (PE), polypropylene (PP), polyvinyl chloride (PVC) etc] |
| polymer layer. | Or its composite with flame retardant |

In the present disclosure, inorganic fiber refers to fiber made from inorganic materials that include, individually or in combination, glass, carbon (referring to the inorganic type), ceramic, basalt, Asbestos, Alumina, Wollastonite, Potassium Titanate, Silicon Carbide, and others.

There may be adhesives used between the film material layers which are laminated to form a single sheet. In some examples, due to high lamination temperature, the polymers in one Film Material Layer may penetrate through another Film Material Layer (especially when woven inorganic fiber is employed), resulting in less defined layer boundaries. Hence, in the actual physical product, the layers may not be as distinct and neatly stacked as shown in FIG. 1 and there can be some overlap or mix-up in the materials of the layers.

By utilising woven inorganic fiber e.g. E-glass with extremely low organic binder (about 0.05 wt % to 1 wt %) as component of film material or filler, the resulting insulation device will have lower overall organic contents for better thermal and fire resistance while maintaining good dielectric properties and mechanical strength. To attain higher tensile strength, S-glass fiber could be used. In the case that even higher thermal resistance is required, T-glass fiber could be used.

With the composition and structure of the above-mentioned examples in Table 1 above, the typical installed density of the Thermal insulation device in a battery module assembly under pressure is about 0.2 to 0.5 g/cm³. At the relaxed state with no pressure exerted, the apparent density of the Thermal insulation device is about 0.05 to 0.4 g/cm³.

The Thermal insulation device 100 may be made, for example, via the following simplified overview of a manufacturing process.
1. Mix functional fillers FF1, FF2 and FF3 homogeneously.
2. Film Material Layers FML1, FML2 and FML3 are laminated to form a single sheet, with film material layers FML1 and FML3 on opposite sides of film material layer FML2. Heat/press sensitive adhesives may or may not be used between the layers. Roll to roll thermal lamination may be used.
3. Form the holes (perforations) in the single sheet using for e.g., a needle roller (or a punch).
4. Form a bag-like structure with one opening using a method such as thermal fusion through the film material layer FML3, with film material layer FML1 on the outer most surface.
5. Dispose the functional filler FF4 adjacent to the inner surface of the bag, forming a void.
6. Dispose the mixture of the functional fillers FF1, FF2 and FF3 into the void, with the functional filler FF4 enclosing the mixture.
7. Close and seal the opening of the bag using a method such as thermal fusion, to form a “blade” structure insulation device.

Some examples of the Thermal insulation device 100 are as follows.

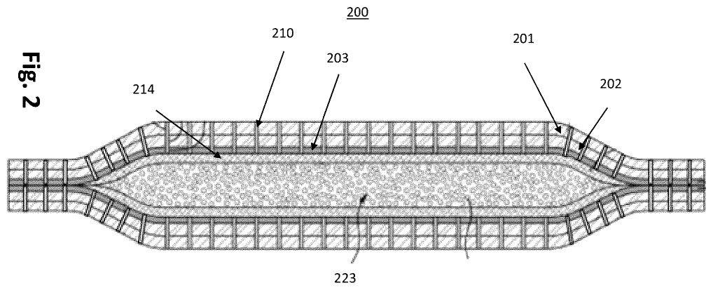

With reference to FIG. 2, an example of the Thermal insulation device 200 is shown. The Thermal insulation device 200 may have a film structure (or film material) comprising an outer layer 201 (e.g. for protecting against external environment condition; corresponds to FML1), a middle layer 202 (e.g. for mechanical strength and enhancing protection against heat and fire; corresponds to FML2), and an inner layer 203 (e.g. for locking distribution of filler inside a cavity and maintain shape of the bag; corresponds to FML3). There are perforations 210 (or holes or micro-perforations or pores or openings or orifices) in the film material layers FML1, FML2 and FML3 201, 202 and 203. The average diameter of the perforations (or holes or pores or openings or orifices) may be about 15 μm or less. The perforations (or holes or pores or openings or orifices) may allow air to be removed from the insulation device 200. Sides of the film material layers are sealed to form a bag which contains functional fillers therein. A functional filler FF4 214 may serve as a reinforcement fiber that encloses the functional fillers FF1, FF2 and FF3 223 therein and is adjacent to the film material layer FML3 203.

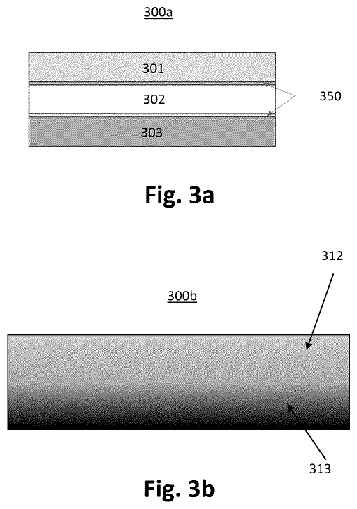

FIG. 3a illustrates a film structure (or film material) 300a of an example of the Thermal insulation device 100 of FIG. 1 or 200 of FIG. 2 comprising a first polymer layer 301 as an outer layer (corresponds to FML1), an inorganic film layer 302 as a middle layer (corresponds to FML2) and a second polymer layer 303 as an inner layer (corresponds to FML3). The layers 301, 302 and 303 are joined via adhesive 350.

An example of the film structure (or film material) 300a of the Thermal insulation device illustrated by FIG. 3a comprises a polymer layer as an outer layer (corresponds to FML1), a woven inorganic fiber (glass fiber) layer as a middle layer (corresponds to FML2) and another polymer layer as an inner layer (corresponds to FML3). Such Thermal insulation device is found to have good performance, such as good thermal and fire resistance while maintaining good dielectric properties and mechanical strength.

FIG. 3b illustrates a film structure 300b of another example of the Thermal insulation device 100 of FIG. 1 comprising an inorganic film layer 312 as an outer layer (corresponds to FML2) and a second polymer layer 313 as an inner layer (corresponds to FML3). The polymer layer 313 is partially melted and mixed or penetrated into the inorganic film layer 312. Such melting, mixture and penetration can be achieved through, for instance, heat lamination. Notably, there is no clear boundary between the inorganic film layer 312 and the second polymer layer 313.

In other examples, the Film Material Layer FML2, Middle Layer 202 in FIG. 2, Inorganic Film Layer 302 in FIG. 3a, and Inorganic Film Layer 312 in FIG. 3b can be specifically E-glass fiber woven textile or fabric.

Table 1a below shows the various tests conducted to compare the performances between Thermal insulation devices having the film structures PET/AL/PE and PET/EG/PE respectively. PET/AL/PE refers to a film structure having a Polyethylene Terephthalate (PET) layer, an Aluminium (AL) layer and a Polyethylene (PE) layer. PET/EG/PE refers to a film structure having a Polyethylene Terephthalate (PET) layer, a Fiber glass (EG) layer (e.g. E-glass woven or non-woven textile, fabric or mat) layer and a Polyethylene (PE) layer.

TABLE 1a
Comparison between EG and AL

| Raw Material | AL Foil | EG Woven Mat |
|---|---|---|
| Melting point | Al melts at ~660 | Thermogravimetric analysis |
| | Degrees Celsius | (TGA -air) tested up to 1000 |
| | (lit) | Degrees Celsius, which shows |
| | | no degradation in sample |
| | | after test. |
| Thermal | 237 W/m · k (lit) | 1.35 W/m · K (lit) |
| Conductivity | | |
| Electrical | Conducting | Insulating |
| Conductivity | | |

The tensile strength and Thermal conductivity of PET/AL/PE and PET/EG/PE are provided in table 1b below.

TABLE 1b
Comparison between Film materials PET/AL/PE and PET/EG/PE

| Film Material | PET/AL/PE | PET/EG/PE |
|---|---|---|
| Tensile Strength | 23 MPa (one ply- | 91 MPa (one ply- |
| (Perforated Film) | laminate direction) | laminate direction) |
| | 25 MPa (one ply- | 68 MPa (one ply- |
| | cross direction) | cross direction) |
| Thermal | Inner layer: 0.160 | Inner layer: 0.101 |
| Conductivity | Outer layer: 0.184 | Outer layer: 0.101 |
| (Tci, W/m · K) | | |

The Thermal conductivities of filled (filled with Thermal insulation particles e.g. aerogel powder) and heat treated Thermal insulation devices made with Film materials PET/AL/PE and PET/EG/PE are provided in table 1c below.

TABLE 1c
Comparison of Thermal insulation devices made
with Film materials PET/AL/PE and PET/EG/PE

| Filled, Heat Treated | | |
|---|---|---|
| Thermal insulation | | |
| device | PET/AL/PE | PET/EG/PE |
| Thermal Conductivity | 0.0157 (24 Degrees | 0.0141 (24 Degrees |
| at 2 kPa (HFM, W/m · K) | Celsius) | Celsius) |
| | 0.0161 (50 Degrees | 0.0150 (50 Degrees |
| | Celsius:) | Celsius) |

The tables 1a to 1c above show that the performance of PET/EG/PE is better than PET/AL/PE in terms of electrical insulation, tensile strength, and thermal conductivity. The main contributing factor is the use of an inorganic fiber layer i.e. EG.

As shown in table 1a, thermal stability, thermal conductivity and electrical conductivity of raw materials i.e. an Aluminium foil and an EG woven mat, are listed. Aluminium melts at about 660 Degrees Celsius, whereas the EG woven mat shows no degradation after the thermogravimetric analysis in air (TGA-air) test up to 1000 Degrees Celsius. This shows that EG is much more thermally stable at high temperatures compared to Aluminium. The thermal conductivity of the EG woven mat is much lower than that of the Aluminium foil. The EG woven mat is a good electrical insulator whereas Aluminium is a good electrical conductor.

Tensile strength of the perforated film and thermal conductivity of the film materials PET/AL/PE and PET/EG/PE are studied. As can be seen in table 1b, the tensile strength of PET/EG/PE is much higher than that of PET/AL/PE, be it in the one ply-laminate direction or in the one ply-cross direction. The thermal conductivity of PET/EG/PE is much lower than that of PET/AL/PE.

In addition, thermal conductivity of a filled, heat treated bags having the films PET/AL/PE and PET/EG/PE are studied. As shown in table 1c, the thermal conductivity of PET/EG/PE is lower than that of PET/AL/PE at both 24 Degrees Celsius and 50 Degrees Celsius.

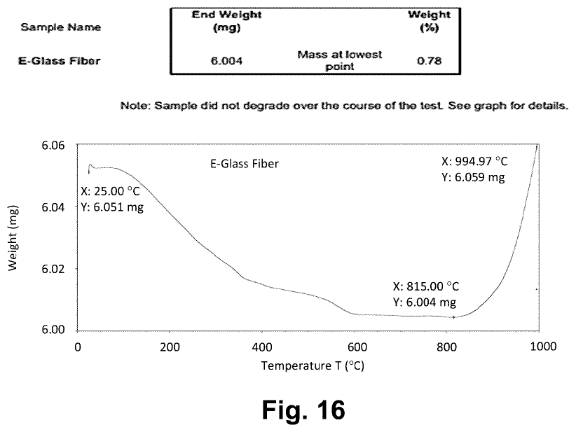

Referring to FIG. 16, the weight of an EG woven mat sample is measured as the temperature is raised from 25 Degrees Celsius to 1000 Degrees Celsius. It can be seen that, even when the weight is at the minimum at 815 Degrees Celsius, the weight change is only 0.78% of the initial weight. This shows that there is insignificant weight change of EG in the temperature range of between 25 Degrees Celsius and 1000 Degrees Celsius.

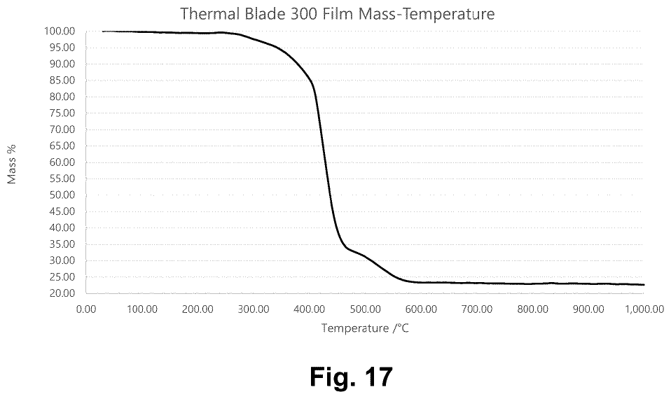

Referring to FIG. 17, the mass of a thermal insulation device having the film structure of PET/EG/PE is measured as the temperature is raised from 25 Degrees Celsius to 1000 Degrees Celsius. It can be seen that the mass of the thermal insulation device remains almost constant in the temperature range of between 25 Degrees Celsius and 260 Degrees Celsius. This shows that the thermal insulation device is stable over a temperature range much higher than the battery operating temperature and thermal runaway temperature. Referring back to FIG. 17, the residue weight remains at 23% between 600 to 1000 Degrees Celsius which is contributed by EG. This shows that the EG woven mat could provide the sufficient heat resistance as a casing material for insulation device after thermal runaway with typically maximum temperature of 900 Degree Celsius.

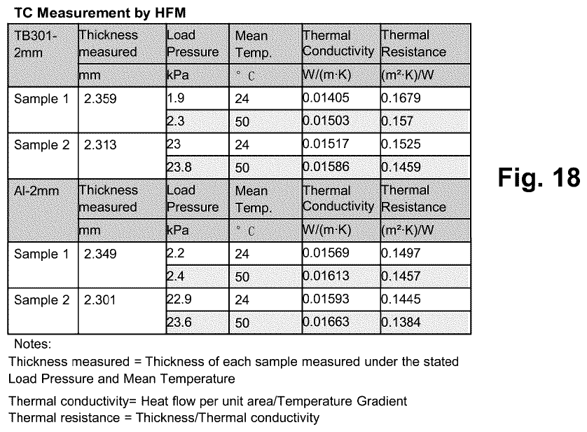

As shown in the table in FIG. 18, thermal conductivity measurement is carried out by the Heat Flow Meter (HFM) on 2 samples of a thermal insulation device (TB301-2 mm) having the film structure of PET/EG/PE and 2 samples of another thermal insulation device (Al-2 mm) having the film structure of PET/AL/PE. In the table, Thickness measured=Thickness of each sample measured under the stated Load Pressure and Mean Temperature; Thermal conductivity=Heat flow per unit area/Temperature Gradient; and Thermal resistance=Thickness/Thermal conductivity.

At two load pressures of around 2 kPa i.e. 1.9 kPa and 2.3 kPa and two temperatures of 24 Degrees Celsius and 50 Degrees Celsius respectively, a sample 1 of TB301-2 mm with a thickness of 2.359 mm has thermal conductivities of 0.01405 W/m·K and 0.01503 W/m·K respectively and thermal resistances of 0.1679 m²K/W and 0.157 m²K/W respectively. At two load pressures of around 23 kPa i.e. 23 kPa and 23.8 kPa and two temperatures of 24 Degrees Celsius and 50 Degrees Celsius respectively, a sample 2 of TB301-2 mm with a thickness of 2.313 mm has thermal conductivities of 0.01517 W/m·K and 0.01586 W/m·K respectively and thermal resistances of 0.1525 m²K/W and 0.1459 m²K/W respectively.

At two load pressures of around 2 kPa i.e. 2.2 kPa and 2.4 kPa and two temperatures of 24 Degrees Celsius and 50 Degrees Celsius respectively, a sample 3 of Al-2 mm with a thickness of 2.349 mm has thermal conductivities of 0.01569 W/m·K and 0.01613 W/m·K respectively and thermal resistances of 0.1497 m²K/W and 0.1457 m²K/W respectively. At two load pressures of around 23 kPa i.e. 22.9 kPa and 23.6 kPa and two temperatures of 24 Degrees Celsius and 50 Degrees Celsius respectively, a sample 4 of Al-2 mm with a thickness of 2.301 mm has thermal conductivities of 0.01593 W/m·K and 0.01663 W/m·K respectively and thermal resistances of 0.1445 m²K/W and 0.1384 m²K/W respectively.

Hence, at similar thicknesses, the thermal conductivity values of the PET/EG/PE device at two load pressures of around 2 kPa and at two temperatures of 24 Degrees Celsius and 50 Degrees Celsius are lower than that of the PETAL/PE device. Furthermore, the thermal resistance values of the PET/EG/PE device is higher than that of the PETAL/PE device. This shows that PET/EG/PE provides higher resistance to heat transfer.

The various studies discussed above show that a thermal insulation device having an inorganic fiber film (or layer), not just specific to EG, over an Aluminium film or layer is found to have good performance, such as good thermal and fire resistance while maintaining good dielectric properties and mechanical strength, and therefore it is a good candidate in terms of safety for thermal insulation and thermal runaway management in an Electric Vehicle battery.

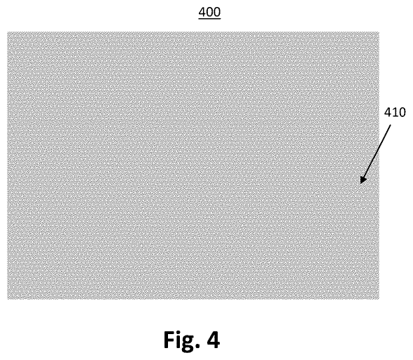

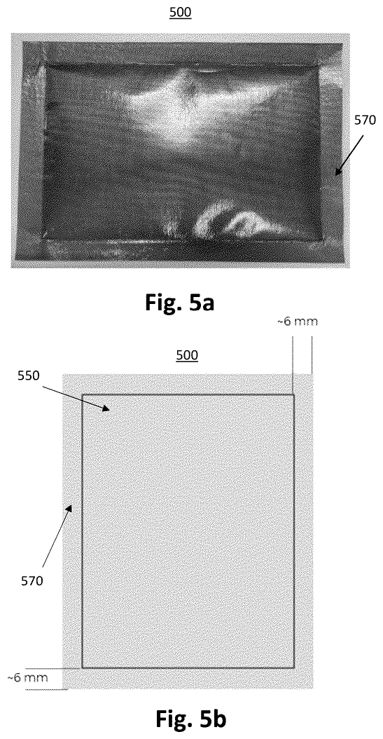

With regard to the examples of FIGS. 2, 3a and 3b, two pieces of the film structure may be arranged to be on opposite sides and be joined and sealed at side edges, and then filled with the functional fillers to form a bag. The fillers may be a free-flowing filler such as aerogel-based material i.e. FF1 and may contain additives like FF2 and/or FF3. The filler is free flowing, for instance, in powder form. The filler may also include a reinforcement fiber that encloses the free-flowing fillers FF1, FF2 and/or FF3 therein and is adjacent to the film material layer FML3. There may be a plurality of holes or perforations provided on all examples of the film structures described in the present disclosure for ventilation and/or degassing purposes. To provide sufficient passage for air/pressure release, the center to center spacing of the perforations may be about 3×3 mm. FIG. 4 shows an example of the surface of a film material layer 400 with perforations 410 therein. FIG. 5a shows an example of a bag 500 made from the film structure, with four-sided seals 570. FIG. 5b shows that the sealing areas of each of the seals 570 of the bag 500 can have a sealing width of about 6 mm around a perimeter of a main body 550 of the bag. Other types of seals may also be useful. For example, the bag may be a 3-sided sealed bag, which will be described below.

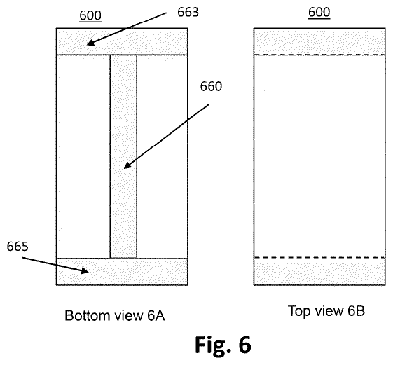

FIG. 6 shows a bottom view 6A and a top view 6B of an example of a bag 600 that is rectangular in shape and having 3-sided sealing. Having bags with other shapes may also be useful. The 3-sided sealing comprises one vertical or centre (straight) seal 660, and two side (straight) seals, namely a top seal 663 and a bottom seal 665. The vertical seal 660 is disposed between the two side seals 663 and 665 and joined to the two side seals 663 and 665 at the ends of the vertical seal 660. The vertical seal 660 can be said to be orthogonal to the two side seals 663 and 665, which are disposed horizontally relative to the side of the bag 600. For example, the seals 660, 663 and 665 of the bag may have a sealing width of between about 10-20 mm.

An overview of an example of how the bag 600 is formed is as follows. A film material is pre-made and can have, for instance, the film structure of the examples described earlier in Table 1 and shown in FIGS. 1, 2, 3a and 3b. The film material from a roll of film is rolled to form a tubular structure and two opposite sides of the film material are joined through the sealing of the vertical seal 660. After the vertical seal 660 is sealed, the bottom seal 665 is sealed and a preformed bag with an open top side or end is formed. The functional filler FF4 may be disposed adjacent to the inner surface of the preformed bag through the open top side or end of the preformed bag, forming a void. The powder or the mixture of the functional fillers such as FF1, FF2 and/or FF3 is dosed or fed into the preformed bag through the open top side or end, with the functional filler FF4 enclosing the mixture. Once the preformed bag is filled, sealing to form the top seal 663 is done to close the opening of the open top side or end. Alternatively, filling the functional filler FF4 is skipped and only FF1, FF2 and/or FF3 are filled into the preformed bag.

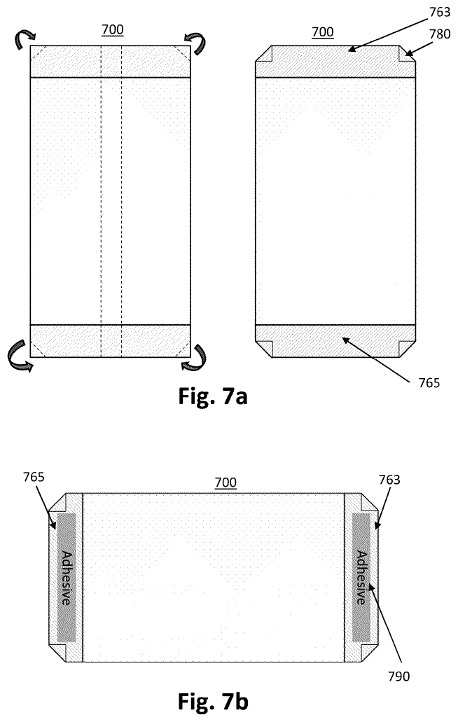

Preferably, horizontal seals or top and bottom seals 763 and 765 may be folded or flapped at the corners of the seals of a preformed bag 700 as shown in FIG. 7a. Such folding or flapping of the corners of the seals is referred to as pre-flapping. Other configurations of the pre-flapping may also be useful. For example, only corners of one of the top and bottom seals are pre-flapped. In another example, only one corner of the top or bottom seals is pre-flapped. In the case of a squarish or rectangular bag, each corner refers to each of the 4-pointed corners. Pre-flapping may be done to prevent leakage of the powder/mixture of the filler at the corners of each bag. Pre-flapping is optional but recommended. The pre-flapping may be conducted with heat treatment to soften the film material while adding pressure to fold the corner. This can make the corner fold stay without unfolding itself.

FIG. 7b shows a front view of the pre-flapped (corner folded) bag 700 of FIG. 7a. In one example, a tape or an adhesive 790 is applied onto sealing areas at the flaps (or sealed sides) of the bag, in particular, the top seal (or sealing area) 763 or a bottom seal (or sealing area) 765 of the bag, which are also known as the horizontal sealing areas of the bag. For example, double-sided tape (or transfer tape) can be applied onto the bag flaps. In another example, adhesive (hot glue) may be applied onto the flaps.

After the tape/adhesive application on the horizontal sealing areas of the bag 700, a flapping process may be performed to flap or fold the horizontal sealing areas so that the portions applied with tape/adhesive adhere to a main body (or core area) of the bag. Folding or flapping the sealing areas onto or under the main body of the bag, effective insulation coverage is maximised. Furthermore, when high temperature and/or pressure is applied on the bag in later processes to degas and compact the contents in the bag, the flapped or folded seals will push onto the main body of the bag more securely and hence, the sealed sides or edges of the bag are less susceptible to the risk of opening and spilling the filled contents.

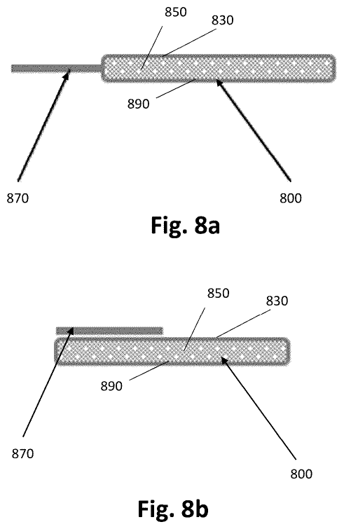

In one example as shown in FIG. 8a-b, the top and bottom seals (only one seal 870 is shown as an illustration) with or without the pre-flapped corners are flapped or folded towards a major surface 830 of a main body 850 of the bag 800. Adhesive or tape may be disposed between the sealed flaps and the major surface 830 (or 890) of the bag so as to stick the flaps to the main body 850 (or core portion) of the bag. Preferably, both the top and bottom sealed flaps are flapped/folded to the same major surface 830 or 890 of the main body 850 of the bag. Alternatively, the top and bottom sealed flaps are flapped/folded to opposing major surfaces 830 and 890 of the main body 850 of the bag. The flapping helps to prevent the flaps from getting in the way of assembly of the bag in another product such as in an Electric Vehicle battery. The flapping also creates an obstruction for the powder at a folding line of the flaps, which helps to prevent the powder from leaking through the sealed flaps in the case that they are not sealed properly or the seal deteriorates and results in decreased sealing performance due to wear and tear, poor storage, or over long periods of time.

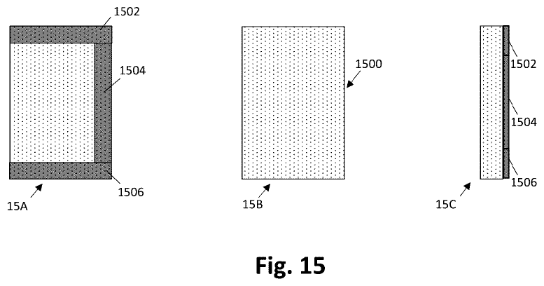

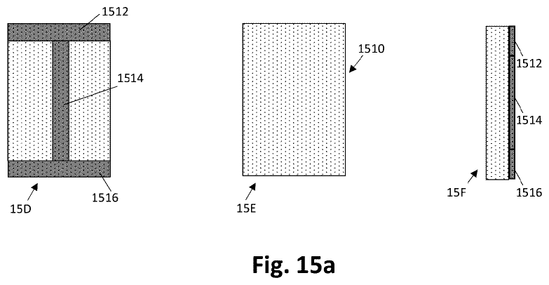

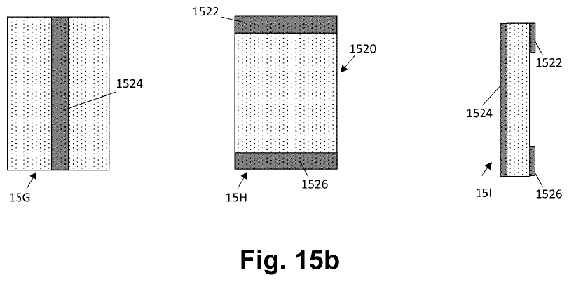

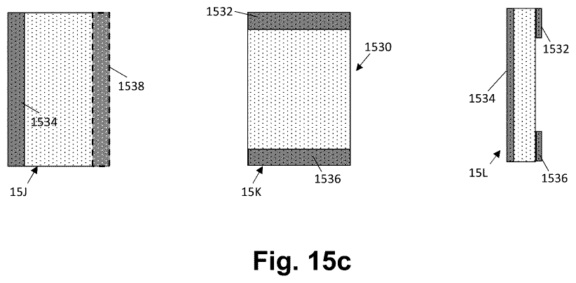

Examples of a fully flapped or folded bag are illustrated in FIG. 15, FIG. 15a, FIG. 15b, and FIG. 15c. These figures will now be described. Note that these figures are not drawn to scale and the thicknesses of the flaps in the side views shown are exaggerated for better illustration.

FIG. 15 shows a rear view 15A, a front view 15B and a side view 15C of a folded bag 1500. The folded bag 1500 has a first folded horizontal seal 1502 (or folded top seal), a second folded horizontal seal 1506 (or folded bottom seal) and a folded vertical seal 1504 (or folded centre seal) that is orthogonal to the first folded horizontal seal 1502 and the second folded horizontal seal 1506. The folded vertical seal 1504 may be folded first. The first folded horizontal seal 1502 and the second folded horizontal seal 1506 may be then folded. In the example of FIG. 15, all the folded seals 1502, 1504 and 1506 are visible in the rear view 15A. The folded vertical seal 1504 is located at an edge of the folded bag 1500 (with respect to FIG. 15, at the left side edge of the folded bag 1500).

FIG. 15a shows a rear view 15D, a front view 15E and a side view 15F of a folded bag 1510. The folded bag 1510 has a first folded horizontal seal 1512 (or folded top seal), a second folded horizontal seal 1516 (or folded bottom seal) and a folded vertical seal 1514 (or folded centre seal) that is orthogonal to the first folded horizontal seal 1512 and the second folded horizontal seal 1516. The folded vertical seal 1514 may be folded first. The first folded horizontal seal 1512 and the second folded horizontal seal 1516 may then be folded. In the example of FIG. 15a, all the folded seals 1512, 1514 and 1516 are visible in the rear view 15D. The folded vertical seal 1514 is located at a central area of the folded bag 1510.

FIG. 15b shows a rear view 15G, a front view 15H and a side view 15I of a folded bag 1520. The folded bag 1520 has a first folded horizontal seal 1522 (or folded top seal), a second folded horizontal seal 1526 (or folded bottom seal) and a folded vertical seal 1524 (or folded centre seal) that is orthogonal to the first folded horizontal seal 1522 and the second folded horizontal seal 1526. The folded vertical seal 1524 may be folded first. The first folded horizontal seal 1522 and the second folded horizontal seal 1526 may then be folded. In the example of FIG. 15b, the folded seal 1524 is visible in the rear view 15G and the folded seals 1522 and 1526 are visible in the front view 15H. The folded vertical seal 1524 is located at a central area of the folded bag 1520.

FIG. 15c shows a rear view 15J, a front view 15K and a side view 15L of a folded bag 1530. The folded bag 1530 has a first folded horizontal seal 1532 (or folded top seal), a second folded horizontal seal 1536 (or folded bottom seal) and a folded vertical seal 1534 (or folded centre seal) that is orthogonal to the first folded horizontal seal 1532 and the second folded horizontal seal 1536. The folded vertical seal 1534 may be folded first. The first folded horizontal seal 1532 and the second folded horizontal seal 1536 may then be folded. In the example of FIG. 15c, all the folded seals 1532, 1534 and 1536 are visible in the rear view 15J. In the example of FIG. 15c, the folded seal 1534 is visible in the rear view 15J and the folded seals 1532 and 1536 are visible in the front view 25K. The folded vertical seal 1534 is located at an edge of the folded bag 2530 (with respect to FIG. 15c, at the right side edge of the folded bag 1530). In another example, the folded vertical seal 1534 may be located at an edge 1538 of the folded bag 1530 (with respect to FIG. 15c, at the left side edge of the folded bag 1530).

By folding the sealing flaps onto or under the core area of the bag as illustrated in FIG. 15, FIG. 15a, FIG. 15b, and FIG. 15c, the effective insulation coverage of the Thermal insulation device can be maximised. In addition, when high temperature and pressure are applied onto the top and bottom of the bag, the sealed flaps can be pushed onto the core area of the bag more securely and hence less susceptible to risk of opening up and spilling the filled contents. Other configurations of sealing flaps being folded onto or under the core area of the bags may also be useful.

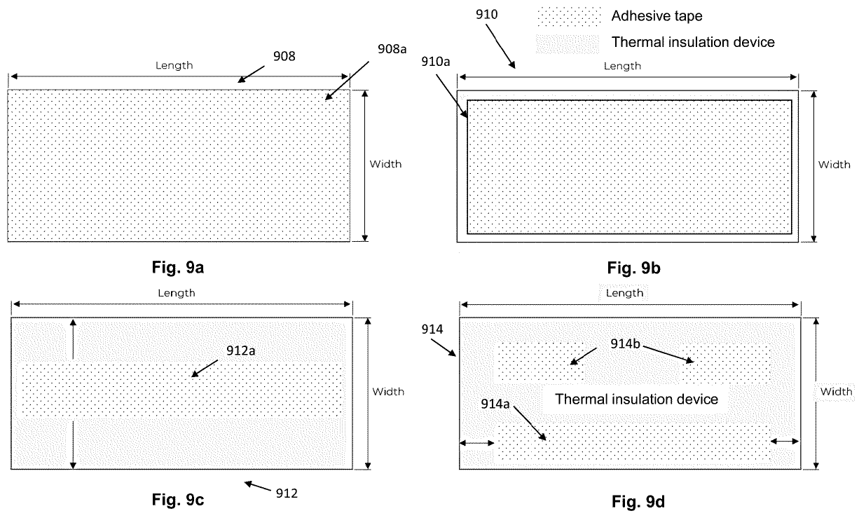

FIGS. 9a-d show that the bag may be provided with an adhesive/tape on one major (front or rear) surface of the bag. The bag can thus be adhered to a surface as required of the application of the bag. A release liner may be provided on the adhesive/tape if the bag is not to be assembled immediately into another component, such as an Electric Vehicle battery. A release liner or release paper is basically a paper or plastic-based film sheet used to prevent a sticky surface from prematurely adhering. The bags/Thermal insulation devices may also be labelled. An ink jet printer or a laser marking system can be used for the labelling. The labelling may include product information (e.g. model number, batch number etc.) and/or manufacturing date.

The adhesive may be in liquid form and sprayed onto the major surface of the Thermal insulation device. Alternatively, double-sided or transfer tape with one side having a release liner may be adhered on the major (front and rear) surfaces of the Thermal insulation device. Thermal insulation devices may have tape/adhesive and release liner on one or both major surfaces thereof.

Specifically, a taping process may be used to apply the adhesive onto the Thermal insulation device. In the case of adhesive application, the adhesive is prepared and applied onto the desired surface of the Thermal insulation device. Thereafter, release liner is pasted on the applied adhesive. In another example, a single sided tape with a release liner on one side may be used. In this case, adhesive is applied first on the desired surface of the Thermal insulation device, followed by sticking the side of single sided tape that does not have release liner to the applied adhesive. In the case of double-sided or transfer tape having two sides with release liners, the release liner or one side of such tape is removed first for pasting the tape on the desired surface of the Thermal insulation device. Tape can be cut to size before or after (preferably before) the tape is adhered to the desired surface of the Thermal insulation device.

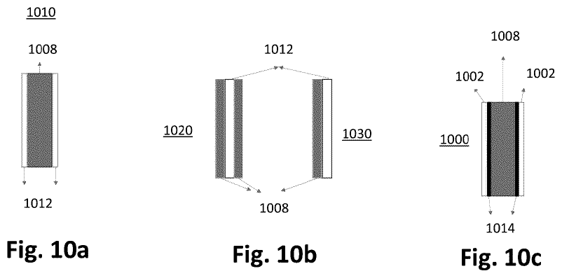

FIGS. 9a-d show different scenarios 908, 910, 912 and 914 of how tape can be applied on one or both major surfaces or sides of the Thermal insulation device. The actual scenario is dependent on the application and can be any one of these scenarios. For example, with regard to scenario 908, tape or adhesive 908a is applied over the whole major surface of the Thermal insulation device. With regard to scenario 910, tape or adhesive 910a is applied over a specific surface area of the Thermal insulation device. With regard to scenario 912, tape or adhesive 912a is applied over a surface area that is variable with respect to the width of the Thermal insulation device. That is, the surface area to apply tape or adhesive is a function of the width. For instance, the surface area may be located the same distance away from width boundary ends of the Thermal insulation device. Such surface area may extend substantially along the length of the Thermal insulation device. The width boundary ends refer to ends located opposite to each other, which are apart by the distance of the width of the Thermal insulation device. With regard to scenario 914, tape or adhesive 914a is applied over a surface area that is variable with respect to the length of the Thermal insulation device. That is, the surface area to apply tape or adhesive is a function of the length. For instance, the surface area may be located the same distance away from length boundary ends of the Thermal insulation device. The length boundary ends refer to ends located opposite to each other, which are apart by the distance of the length of the Thermal insulation device. Furthermore, more than one other tape or adhesive 914b covering specific surface areas may be applied at specific positions. In this scenario, the tape or adhesive 914b are relatively smaller size compared to the tape or adhesive 914a. Peelable release liners are to be provided for the applied tape or adhesive 908a, 910a, 912a, 914a, and 914b to enable them to stick to surfaces as required. FIGS. 10a-c illustrate 4 products (or compositions or devices) 1010, 1020, 1030, and 1000. An intumescent (fire retardant) sheet 1012 (to be described later) may be adhered or placed on one or more major surfaces of the Thermal insulation device 1008. Instead of the intumescent sheet 1012, an intumescent coating (also given the reference numeral 1012) may be coated over one or more major surfaces of the Thermal insulation device 1008. Examples of such intumescent coating includes fire-retardant paint and the impregnating solution that can be used to make a type of Fire-retardant device to be described later.

In FIG. 10a, the product 1010 comprises the Thermal insulation device 1008 and two intumescent sheets or coating 1012 disposed at the two major surfaces of the Thermal insulation device 1008.

In FIG. 10b, the product 1020 comprises two Thermal insulation devices 1008 disposed at the two major surfaces of one layer of the intumescent sheet 1012. The intumescent sheet 1012 in product 1020 can also be the intumescent coating (also given the reference numeral 1012). The product 1030 comprises one Thermal insulation devices 1008 disposed at one major surface of one layer of the intumescent sheet 1012.

In FIG. 10c, the product 1000 comprises the Thermal insulation device 1008 and two Fire-retardant devices 1002 disposed at the two major surfaces of the Thermal insulation device 1008. Adhesive in the form of tape or a coated film such as the adhesive film 1014 may be used to adhere the two Fire-retardant devices 1002 to the Thermal insulation device 1008. Fire-retardant devices are not necessarily intumescent. However, the Fire-retardant devices 1002 is preferably an intumescent sheet like the Fire-retardant device described below.

The products 1000, 1010, 1020, and 1030 illustrated in FIGS. 10a-c can be used with or without a frame structure which will be described later.

In the present disclosure, a Fire-retardant device refers to an intumescent sheet suitable for, but not limited to, thermal runaway management of an Electric Vehicle battery. The thickness of the sheet is less than 2 mm, and preferably thinner than or equal to 1 mm. For example, the intumescent sheet is formed by impregnating non-woven inorganic fiber with alkali-silicate based solution (known as “impregnating solution” in the present disclosure). The impregnating solution may be a water-based intumescent coating containing aerogel. The impregnating solution may comprise additives and after it is dried and/or cured, the intumescent sheet has an alkali silicate based coating with the additives. This Fire-retardant device is the FR Device 1002 in FIG. 10c. The intumescent sheet 1012 in FIGS. 10a-b may also be this Fire-retardant device. The term “Fire-retardant device” refers to said Fire-retardant device throughout the present disclosure.

The composition of the intumescent sheet (after drying) and the composition of the impregnating solution of an example of the Fire-retardant device is described as follows.

The intumescent sheet may comprise a non-woven inorganic fiber mat (or fabric) e.g. ECR-50 from Owen's Corning (a type of E glass). The impregnating solution used for this product comprises a sodium-silicate based binder and aerogel fine particles with hydrophobic surface groups. The particle size of the aerogel particle is between 10-60 μm and its porosity is more than 90%. Alumina (a type of metal oxide) and metal dihydroxide (a type of metal hydroxide) is added as an additive into the impregnating solution to improve the mechanical robustness, insulation and fire-retardant properties of the char.

The tables 2a and 2b below show examples of the composition of the Fire-retardant device after drying and the composition of the impregnating solution. Table 3 below shows selected properties of the Intumescent Sheet.

TABLE 2a
Composition of the Intumescent Sheet (After Drying)

| | | Preferred loading |
|---|---|---|
| | | level (weight % |
| | | of the intumescent |
| Constituents | Function | sheet) |
| Dried sodium silicate | Binder | 75-85 |
| Surfactant | Dispersing Agent | 0.2-1.2 |
| Aerogel fine particles | Main Performance | 1-5 |
| with hydrophobic | Agent (Thermal | |
| surface groups | insulation imparting | |
| | additive) | |
| Metal oxides/hydroxides | Sub Performance | 3-8 |
| (e.g. alumina and | Agent (Char strength | |
| magnesium dihydroxide) | enhancing ceramic | |
| | additive) | |
| Non-woven glass fiber mat | Main Performance | 8-16 |
| (e.g. ECR-50 from Owen's | Agent | |
| Corning (a type of E glass) | | |

TABLE 2b
Composition of the impregnating solution

| | | Preferred Loading |
|---|---|---|
| | | level (weight % of |
| Constituents | Function | the solution) |
| Sodium silicate (aqueous, | Binder | 92-97 |
| 60 wt % water) | | |
| Surfactant | Dispersing Agent | 0.2-1 |
| Aerogel fine particles | Main Performance | 0.8-2 |
| with hydrophobic | Agent (Thermal | |
| surface groups | insulation imparting | |
| | additive) | |
| Metal oxides/hydroxides | Sub Performance | 2.0-4.5 |
| (e.g. alumina and | Agent (Char strength | |
| magnesium dihydroxide) | enhancing ceramic | |
| | additive) | |

TABLE 3
Selected properties of the Intumescent Sheet.
Selected Properties of the Intumescent sheet

| Property | Value | |
|---|---|---|
| Density of sheet after curing | 1-2 | g/cm³ |
| Expansion Ratio (Char | 3-4.5 | |
| thickness/original sheet thickness) | | |
| Thermal Conductivity of | 0.04-0.15 | W/mK |
| char after expansion | | |

| | |
|---|---|
| Compressive Strength of char | At 20% strain: 40-300 kPa; |
| | At 40% strain: 250-300 kPa; |
| | At 60% strain: 1000-1400 kPa; and |
| | At 80% strain; 1650-2100 kPa |

Surfactant that is stable in a range of pH 2 to 12 may be added to the impregnating solution to improve the ability to spread and wet the non-woven inorganic fiber mat. Preferably, the surfactant is chosen from a group comprising of an amine oxide, an alkyl carbohydrate ester, an alkoxylated polysiloxane and a poly alkyl acrylate. The surfactant loading level may be between 0.2 to 0.5 wt % of the impregnating solution, whereas the preferred loading level may be 0.2 to 1.2 wt % of the intumescent sheet.

With regard to the non-woven inorganic fiber mat of the Fire-retardant device, besides E-type glass, S-type is another preferred option. If E-type glass is used, E-type glass with boron oxide element removed is most preferred. The diameter and length of the fiber should be between 10-15 μm and 15-60 mm.

Other thermal insulation imparting additive (i.e. an agent that enables formation of char with a dense network) that is microporous, such as fumed silica, hollow microglass spheres, can also be used. Other suitable char strength-imparting ceramic additives can also be used, e.g. a combination of metal oxide, metal hydroxide, metal carbonate, metal silicate, and/or metal powder.

In addition to the constituents described above, optionally, the intumescent sheet can be added with 1 to 10 wt % of an opacifier, such as iron oxide, silicon carbide, and/or titania. The opacifier provides high temperature thermal insulation and serves to reflect and thereby reduce heat transfer via radiation at high temperatures.

The organic additive can be added at the impregnation station (where the impregnation of the non-woven inorganic fiber mat and the impregnating solution is performed) to enhance flexibility and water resistance of the intumescent sheet. Glycerol and polyvinyl alcohol are preferred examples of organic additives.

The production of the impregnating solution involves the sequential addition of alkali-silicate solution and one or more surfactant(s), followed by insulation imparting agents, char strength-imparting agents and other additives, and finally the necessary amount of water with stir-mixing after each step (i.e. after adding each component sequentially) for 15 mins and finally stir-mixing solution with all added components for a further 2-3 hours. Hardening agent is the last constituent to be added into the impregnating solution and it is just before impregnating the non-woven inorganic fiber mat. The viscosity is preferably between 200-500 centipoise (cps).

The hardening agent is preferably sodium fluorosilicate or Potassium methyl siliconate (being the most preferred).

If opacifier, hardening agent, and water are added, the composition of the impregnating solution is in Table 4 as follows.

TABLE 4
Composition of the impregnating solution (A
variant of the product in Table 2b above)

| | Loading level (wt % |
|---|---|
| Constituents | of the solution) |
| Sodium silicate (aqueous, 60 wt % water) | 70-95 |
| Surfactant | 0.05-2 |
| Aerogel fine particles with hydrophobic | 0.5-10 |
| surface groups | |
| Metal oxides/hydroxides (e.g. alumina and | 1-10 |
| magnesium dihydroxide) | |
| Opacifier | 1-10 |
| Organic additive (e.g. glycerol) | Less than 10 |
| Hardening agent (e.g. potassium methyl | Less than 10 |
| siliconate) | |
| Water | 2-10 |

To produce the intumescent sheet, the non-woven inorganic fiber mat is firstly layered on a non-stick polymeric sheet and impregnated by an aqueous alkali-silicate based solution (i.e. the impregnating solution).

Various methods of impregnation could be adopted such as spraying, brushing and/or doctor-blading. Preferably, doctor-blading is adopted for better thickness control and viability for high volume production. Drying is then performed at a suitable temperature (e.g. room temperature) to remove the water without causing defects such as warping. Optionally, curing can be performed at a higher temperature (e.g. via microwave heating) to quicken the process.

Other char strength enhancing additives that may be added include Zirconium Oxide and Colloidal silica. Sodium Silicate is defined by the molar ratio between Silica:sodium oxide. Increasing the ratio of silica enables the formation of a stronger char and the addition of Colloidal silica can adjust the increase.

An example of the Fire-retardant device may have the following intumescent properties such as it is able to react rapidly at temperatures >175 Degrees Celsius, expand to 5 times its original thickness, create an insulating foam that fills voids and reduces heat transfer, is non-combustible, and has an inorganic formulation. The example of the Fire-retardant device may be a flexible sheet material, manufactured in bulk rolls for lamination and die-cutting. The Fire-retardant device may be available in standard thickness of 0.4 mm-1.0 mm. See Tables 4a and 4b below for details of the present example of the Fire-retardant device.

TABLE 4a
Typical Properties

| Property | Value |
|---|---|
| Thickness | About 0.4 mm |
| Weight per unit area | 650 g/sqm +/− 10% (0.133 lb/sq. ft) |
| Expansion activation | 150-200 Degrees Celsius |
| temperature | (302-392 Degrees Fahrenheit) |
| Tensile Strength | >300N (MD), >150N (TD), ISO 1924-2 |
| Expansion Ratio | 4-5 times initial thickness at |
| | 600 Degrees Celsius |
| Compressive Strength | 17% strain at 500 kPa |
| Thermal Conductivity at | <0.06 +/− 0.01 W/(m-K) at |
| five-times expansion | 24 Degrees Celsius) |

TABLE 4b
Product Range

Property

| Colour | White | |
|---|---|---|
| Thickness, mm (in) | 0.40-1.00 (0.016-0.04) | ISO 534: 2011 |
| REACH | Compliant | REACH candidate list of |
| | | SVHC 10 Jun. 2022 |
| RoHS | Compliant | RoHS Directive (EU) |
| | | 2015/863 |

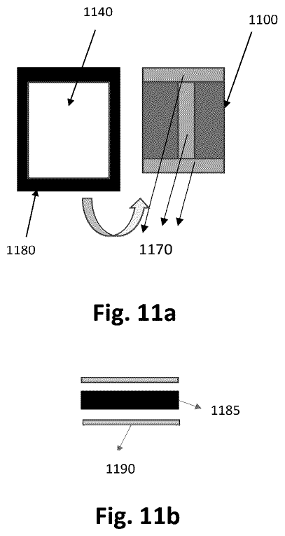

FIGS. 11a-b illustrates an example of steps to frame and seal a bag of Thermal insulation device 1100. In this example, the bag of the Thermal insulation device 1100 is sealed by 3-sided sealing and has 3 seal areas 1170. It should be appreciated that in another example, a 4-sided sealed bag may be used if desired. These 3 seal areas 1170 comprises a first and second horizontal seal areas having the width of the bag 1100 as their length and they are residing at edges of the bag 1100 opposite to each other. The third centre seal is orthogonal to the first and second horizontal seal areas.

Firstly, the Thermal insulation device 1100 is inserted into a main opening 1140 of a single piece frame structure 1180 (e.g. a silicone frame) to form a Framed Thermal insulation device 1185. Secondly, electrically insulating film layers 1190 are added or laid entirely or partially over major surfaces of the Framed Thermal insulation device 1185. Heat and Pressure are applied to these film layers 1190 to heat them and soften and/or melt them to become seals.

A Framed Thermal insulation device may also include a combination of a Thermal insulation device and a Fire-retardant device. If a Framed and sealed Thermal insulation device and Fire-retardant device is to be made using the framing and sealing process described above, the Thermal insulation device 1100 described may be replaced by, for example, a Thermal insulation device adhered to 2 Fire-retardant device layers. Other combination configurations of thermal insulation devices and Fire-retardant devices may also be useful.

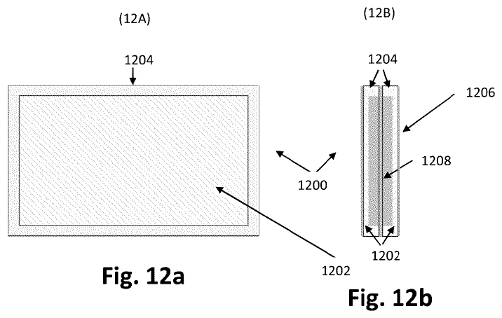

FIGS. 12a-b show a first example of a Framed Thermal insulation device 1200. FIG. 12a is a top view 12A of the Framed Thermal insulation device 1200 and FIG. 12b is a cross-sectional view 12B thereof. The Framed Thermal insulation device 1200 comprises the Thermal insulation device 1208 and two layers of the Fire-retardant (FR) device 1202. Each layer of the FR device 1202 is disposed on each side of the major surfaces of the Thermal insulation device. The Thermal insulation device 1208 is sandwiched between the two layers of the FR device 1202. A frame structure 1204 made up of top and bottom layers of frames is provided to cover the sides or edges along a perimeter of the Thermal insulation device 1208. A layer of sealing 1206 is provided over each major surface of the Framed Thermal insulation device 1200. The sealing 1206 forms an external protective layer over the exposed major surfaces of the two layers of FR device 1202.

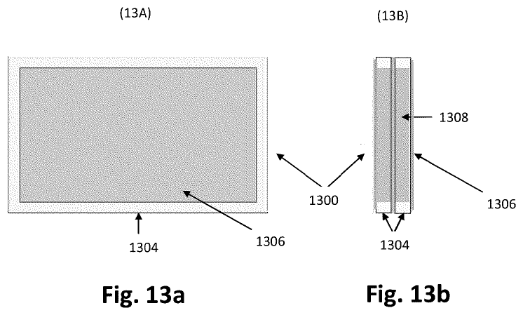

FIGS. 13a-b show another example of a Framed Thermal insulation device 1300. FIG. 13a is a top view 13A of the Framed Thermal insulation device 1300 and FIG. 13b is a cross-sectional view 13B thereof. The Framed Thermal insulation device 1300 comprises the Thermal insulation device 1308, wherein the sides or edges along (or around) a perimeter of the Thermal insulation device 1308 are sandwiched in a frame structure 1304 made up of top and bottom layers of frames. A layer of sealing 1306 is provided over each major surface of the Framed Thermal insulation device 1300. The sealing 1306 forms an external protective layer over the exposed major surfaces of the Thermal insulation device 1308.

Table 5a below shows an example of the specification of a frame structure with 2 frame layers.

TABLE 5a
Example of Frame specification

| Frame material: | E.g. Silicone or other similar or suitable material | |
|---|---|---|
| Frame size: | 148 × 98 | mm |
| Frame width: | ~5-6 | mm |

| | |
|---|---|
| Frame thickness: | 1.5 mm per frame |
| Frame | E.g. Fire resistant adhesive (to be used to adhere |
| adhesive: | to the Thermal insulation device or its combinations) |

Examples of range of dimensions and weight of the Framed Thermal insulation device and its combination with/without Frame and with/without Fire-retardant device for Electric Vehicle Battery application are provided in table 5b below.

TABLE 5b
Examples of range of dimensions and weight of the Framed
Thermal insulation device and its combination with/without
Frame and with/without Fire-retardant device

| Description | Minimum | | Maximum | |
|---|---|---|---|---|
| Width and length of 1 pack of | 50 mm × 50 mm | | 200 mm × 700 mm | |
| Thermal insulation device | (Width × Length) | | (Width × Length) | |
| width and length | | | | |
| Thickness of 1 pack of | 1 | mm | 10 | mm |
| Thermal insulation device | | | | |
| Functional filler weight of the | 0.2 | | 280 | g |
| Thermal insulation device (for | | | | |
| filling density of 0.1 to 0.3 | | | | |
| g/cm³) | | | | |
| Weight of film of cover | 1.0 | g | 60 | g |
| material used for the bag of | | | | |
| the Thermal insulation device | | | | |
| (e.g. comprising 3 | | | | |
| layers, PET- Polyethylene | | | | |
| Terephthalate, EG- Fibre | | | | |
| glass and PE- Polyethylene) | | | | |
| Total weight range of a typical | 1.2 | g | 340 | g |
| Thermal insulation device | | | | |
| without Frame | | | | |
| Frame weight (Silicone | 3.7 | g | 120 | g |
| material) | | | | |
| Total weight range of a | 4.9 | g | 460 | g |
| Framed Thermal insulation | | | | |
| device | | | | |
| Width and length of 1 piece | 50 mm × 50 mm | | 200 mm × 700 mm | |
| Fire-retardant device | (Width × Length) | | (Width × Length) | |
| Thickness of 1 piece of Fire- | 0.5 | mm | 1 | mm |
| retardant device | | | | |
| Weight of 1 piece of Fire- | 1.75 | g | 196 | g |
| retardant device | | | | |
| Total weight of Framed | 8.4 | g | 852 | g |
| Thermal insulation device | | | | |
| with 2 pieces of Fire-retardant | | | | |
| device | | | | |

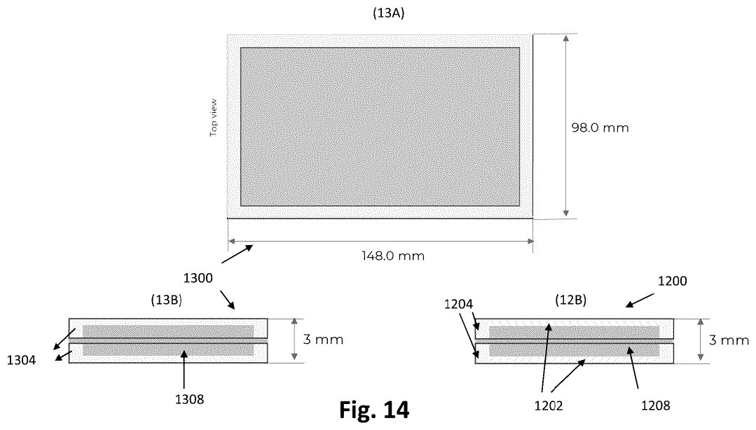

FIG. 14 shows enlarged views of the top view 13A in FIG. 13a, the cross-sectional view 13B in FIG. 13b and the cross-sectional view 12B in FIG. 12b. FIG. 14 shows specific examples of possible dimensions of the first example of the Framed Thermal insulation device 1200 and the second example of the Framed Thermal insulation device 1300. The length and width of the Framed Thermal insulation device 1300 can be about 148 mm and 98 mm respectively. The Framed Thermal insulation device 1200 (top view 12A is not shown in FIG. 14) can have the same length and width as well. The thickness of the Framed Thermal insulation device 1200 and the Framed Thermal insulation device 1300, excluding the sealing, can be about 3 mm. Each of the two layers of the frame structure 1204 in the Framed Thermal insulation device 1200 and the Framed Thermal insulation device 1300 can be about 1.5 mm in thickness. The Thermal insulation device 1308 in the Framed Thermal insulation device 1300 can have a thickness of 2 mm. Each of the two layers of the Fire-retardant device 1202 in the Framed Thermal insulation device 1200 can be about 0.5 mm in thickness. The Thermal insulation device 1208 in the Framed Thermal insulation device 1200 can have a thickness of 2 mm.

An example of a manufacturing process of the Thermal insulation device is described as follows.

At a step (1), raw materials are received and checked to ensure the right materials and quantity are received.

At a step (2), the raw materials are stored in a raw material warehouse.

At a step (3), powders required for making a mixed powder (i.e. the final powder to fill each bag of the Thermal insulation device) are unpacked and placed in one or more mixing buffers. A buffer refers to a container or storage for holding or storing powder. The buffer may be a hopper. Each mixing buffer may contain different types of powder. For instance, one of the mixing buffers may hold silica aerogel fine particles and another mixing buffer may hold metal oxide (opacifier) powder. If other materials are to be added, a further mixing buffer can hold them. A mixing buffer may be a bowl or funnel shaped component with a wide receiving area and has sufficient depth or height for holding powder.

At a step (4), powder is dosed or dispensed from the one or more mixing buffers in the right quantities to a mixer.

At a step (5), the mixer mixes the powder dosed or dispensed to the mixer for mixing. A mixing stirrer or other suitable equipment may be provided for mixing the dispensed powders homogeneously.

At a step (6), mixing quality is checked. For instance, computer vision or X-ray may be used to detect whether the mixed powder is sufficiently homogeneous.

At a step (7), the mixed powder that has passed the quality check is dispensed or transported to a mixed powder buffer or storage.

At a step (8), the mixed powder obtained after step (7) is transported to or poured into a filling hopper for filling powder into bags. The filling hopper is attached to an apparatus or a machine and is configured to feed the apparatus with the mixed powder.

At a step (9), the apparatus performs film and/or bag forming, powder dosing, filling of formed bag, sealing of bag and cutting of filled bag to individual bag size. As examples, a vertical or horizontal forming, filling and sealing machine can be used. After step (9), a bag containing the mixed powder is formed by the apparatus. Each bag can be made from one or more rolls of film being feed to the apparatus for shaping to form the bag. A sheet of film may be perforated and packaged in a roll of film. Each sheet of film may comprise multilayers, for instance, the film material layers FML1 and/or FML2 and/or FML3 may form the multilayers. In one example, the film material for forming the bag is pre-made and provided in a bulk roll for bag forming. The perforations should be small enough to prevent powder from leaking through the perforations.

At a step (10), a quality check on the filling is done. This is done through a weight check. Each bag is weighed to check that it satisfies a pre-determined weight requirement. A bag not satisfying the weight requirement will be rejected and stored in a rejected product container. Depending on the condition of the rejected products, each of them may be subjected to the weight check again or refilled. Good bags or bags that passed the quality check will be transported to the next station for further processing. Assuming that a squarish or rectangular shaped bag is to be formed, the formed bag at the end of step (10) will have 3 or 4 sides with a flap formed due to the side sealing done by the apparatus at step (9).

At a step (11), a first cleaning step is conducted to clean each bag that has passed the quality check at step (10). After cleaning, an optional quality check on the cleanliness of each bag is done. The cleaning can be done via air purging i.e. air is blown over the bag to clean it and/or the bag is subject to vacuum suction wherein powder (if any) is sucked from the bag and/or through other suitable cleaning methods. This first cleaning step is useful, for instance, in the case that powder leaks (or spills) at the filling hopper or at the apparatus, a bag bursts or leaks at step (9) or (10). Step (11) is optional but recommended.

At a step (12), pre-flapping is done. Such pre-flapping refers to the flapping or folding of each corner of each bag. In the case of a squarish or rectangular bag, each corner refers to each of the 4 pointed corners. This is done to ensure that powder leaks will not occur at the corners of each bag. Step (12) is optional but recommended.

At a step (13), after pre-flapping is done or if pre-flapping is skipped, adhesive or tape is applied on the flaps of the bag in preparation for flapping or folding the flaps to stick them to the body of the bag.

At a step (14), flapping or folding of the flaps of each bag to stick them to the body of the bag is performed. This flapping step helps to prevent the flaps from getting in the way of assembly of the bag in another product such as in an Electric Vehicle battery. The flapping also creates an obstruction for the powder at a folding line of the flaps, which helps to prevent the powder from leaking through the sealed flaps in the case that they are not sealed properly or the seal deteriorates and results in decreased sealing performance due to wear and tear, poor storage, or over long periods of time.

At a step (15), a quality check on the flapping is done. Computer vision techniques can be used for this check.

At a step (16), levelling of each bag is performed to distribute the powder inside the bag homogeneously. For example, this can be done by vibration. This step can be performed independently before degassing, or combined with the degassing process described below.

At a step (17), each flapped bag is transported to a station for conducting 1) degassing, 2) heating and 3) cooling of the bag. These 3 steps can be conducted in the following manner. During degassing, the bag is compressed to let air escape the bag. Degassing and compression can help to compact the functional fillers in the bag. Such degassing involves exerting pressure on the major surfaces of the bag to flatten the bag. As the film layers of the bag contain micro-perforations, the gas is released through these perforations. After or during pressure exerting, the bag is heated and during heating, for instance, the film layers soften to form the bag, which helps to release more gas from the bag. After heating, the bag is subjected to cooling. The cooling can be active cooling, in which temperature is brought down actively to cool down the bag fast. Alternatively, the cooling can be done naturally as well. Preferably, the bag is put under compression throughout the 3 steps.

At a step (18), a second cleaning step is conducted to clean each bag that has been degassed at step (17). An optional cleaning quality check can be done after cleaning as well. The cleaning can be done via air purging i.e. air is blown over the bag to clean it and/or subject to vacuum suction, wherein powder (if any) is sucked from the bag and/or through other suitable cleaning methods. This second cleaning step is useful, for instance, in the case that powder leaks (or spills) from a bag or a bag bursts during step (16). Step (18) is optional but recommended.

At a step (19), an optional but recommended End of Line inspection (quality check) should be done for each bag. Through computer vision techniques or other suitable methods, the bag weight, dimensions, visual appearance, creasing and flatness, powder leakage, and/or thickness etc. are inspected to ensure that quality requirements are met. An optional bag labelling or marking step can be performed after the inspection. At this labelling or marking step, for instance, an inkjet or laser printer can be used to label or mark out manufacturing details, and/or product details etc. on the external film layer of each bag.

At a step (20), an optional taping step of the bag may be performed to provide the bag with a tape so that the bag can be adhered to a surface as required of the application of the bag. A release liner may be provided on the tape if the bag is not to be assembled immediately into another component, such as an Electric Vehicle battery. A release liner or release paper is basically a paper or plastic-based film sheet used to prevent a sticky surface from prematurely adhering.

At a step (21), the quality of the taping performed at step (20) is checked to ensure that the taping and/or release liner attachment is done properly. Computer vision techniques can be used for this check.

At a step (22), the bag is packaged and made ready for delivery. For instance, this can be done by first stacking and strapping the bags into bundles and the bundles are then packed into cardboard boxes.

At a step (23), cardboard boxes filled with bags are stacked on a pallet.

At a step (24), the pallet is transferred to a pre-delivery warehouse, ready to be delivered.

In general, the key components of the abovementioned manufacturing process are forming of a bag and filling of powder into the bag, flapping of sealed sides of the bag, degassing and heat treatment.

An example of a method of manufacturing the Framed Thermal insulation device and its combinations is described as follows. There can be a step (A) of Bag preparation and filling, a step (B) of Framing, a step (C) of Degassing, a step (D) of Fire-retardant (FR) device insertion, and a step (E) of Sealing. The Framed Thermal insulation device comprises the Thermal Insulation device, which is in the form of a bag containing functional fillers described previously.

The step (A) of Bag preparation and filling can be the steps (1) to (15) (with or without the steps previously described as optional) described earlier. The outputs of step (A) can be bags of the Thermal insulation device that are not yet degassed, heat-treated and cooled. Alternatively, the outputs of step (A) can be bags (i.e. bags already degassed, heat-treated and cooled) that are made by the steps (1) to (24).

The step (B) of Framing receives the outputs of step (A). The outputs of step (B) would be Framed Thermal insulation devices. For an example of a frame structure comprising 2 parts or 2 frame layers, during frame assembly, a pick-and-place robot may be used, for example, a 6-axis robot. In a first step, a bottom frame is laid on a platform or fixture. In a second step, one or more bags of the Thermal insulation device is placed on the bottom frame. In a third step, a top frame is placed over the Thermal insulation device. After the third step, the Thermal insulation device will be sandwiched in between the top frame and the bottom frame. For the Thermal insulation device to be bonded to the top frame and the bottom frame, there are intermediate bonding steps between the first step, the second step and the third step. The bonding can be done using adhesive. The adhesive can be in the form of tape such as double-sided tape or transfer tape. It may be that in a first scenario, the top frame is adhered to the bottom frame or that in a second scenario, the top frame is adhered to the bag and the bottom frame is adhered to the bag. The second scenario can apply if the bag is thick and the top frame is unable to contact the bottom frame when they are placed over the bag. Although a frame structure with 2 frame layers is described, a frame structure that is a single piece structure can be adapted for the process presently described accordingly.

The step (C) of degassing can be performed by a degassing conveyor apparatus/system. This degassing conveyor system may or may not perform heat treatment on the framed bag. The purpose of the degassing is to remove the excessive air from the inside of each bag of the Thermal insulation device if the bag is not previously degassed or not sufficiently degassed. Degassing also helps to secure the frame structure of each bag (i.e. to secure the 2 frame layers together or to secure them over the 2 frame layers). An example of the degassing conveyor apparatus/system comprises a top conveyor and a bottom conveyor. The top (or upper) conveyor comprises a plurality of interconnected top plates arranged to move in an endless loop and the bottom (or lower) conveyor comprises a plurality of interconnected bottom plates arranged to move in an endless loop. Each top plate works with a bottom plate to compress a framed bag of the Thermal insulation device placed between these plates so as to degas the framed bag. The distance between the top plate and the bottom plate can be adjusted to exert or release pressure on the framed bag.

Each top plate and/or the bottom plate may be configured to facilitate degassing of each bag via vacuum suction. A surface of the top plate and/or the bottom plate for contacting the framed bag may be perforated with a plurality of perforations and is connected to a vacuum suction unit to draw or suck air through the perforations. Vacuum suction will be used to degas a bag when the perforated surface of the top plate or the bottom plate contacts the framed bag.

After or before degassing, the step (D) of FR Device insertion can be performed to insert one or more FR Devices into the Framed Thermal insulation device. The input to this process is the Framed Thermal insulation device with an opening defined by frame layers exposing the Thermal insulation device. Each frame layer covers the perimeter of the Thermal insulation device and has a hollow center, which corresponds to such opening. At a first step, a first Fire-retardant device is placed into a first opening of a top or bottom frame layer. The first Fire-retardant device would contact the Thermal insulation device after it is inserted. At a second step, the top or bottom major surface of the Framed Thermal insulation device is sealed to secure the first Fire-retardant device in the first opening. At a third step, the Framed Thermal insulation device is flipped. At a fourth step, the second Fire-retardant device is inserted into the second opening of the bottom or top frame layer respectively. The second Fire-retardant device would contact the Thermal insulation device after it is inserted. At a fifth step, the respective bottom or top surface of the Framed Thermal insulation device is sealed to secure the second Fire-retardant device in the second opening. Details on the sealing process will be described below.

Step (E) involves sealing of the Framed Thermal insulation device, preferably immediately after the FR Device is inserted into the Framed Thermal insulation device. After insertion of the first Fire-retardant device, the external major surface of the Framed Thermal insulation device with the inserted first Fire-retardant device is sealed before the Framed Thermal insulation device is flipped for the insertion of the second Fire-retardant device. A seal layer is applied over the Framed Thermal insulation device, which contains the inserted first Fire-retardant device. After the Framed Thermal insulation device is flipped and the second Fire-retardant device is inserted, another seal layer is applied over the external major surface of the Framed Thermal insulation device with the inserted second Fire-retardant device of the Framed Thermal insulation device. The final sealed and framed Thermal insulation device contains a Thermal insulation device between 2 Fire-retardant devices and 2 frame layers, and the two major surfaces of the Thermal insulation device are sealed. A label (or seal) applicator is a possible equipment to be used to apply the sealing. The seal may be a coating or a thin film of a suitable plastic material (e.g. a polymer sheet). In another example, electricity is passed to thin film layers of seal material to heat them and soften and/or melt them to become seals that can attached to the external major surfaces of the Framed Thermal insulation device.

Examples of the present disclosure may have the following features. The reference numerals in parentheses refer to the reference numerals of the elements in the Figures.

A thermal insulation device (e.g. 100, 200, 500, 600, 1010, 1020, 1030, 1000, 1200, 1300, 1500, 1510, 1520, 1530) comprising:
functional fillers (e.g. FF1, FF2, and/or FF3) enclosed in a bag, wherein the bag is made of a film material (e.g. a combination of FF4, FML1 to FML3; 300a, 300b, 400) comprising at least:
an inorganic fiber layer (e.g. FML2 102); and
a polymer layer (e.g. FML3 103),
wherein the inorganic fiber layer is layered over the polymer layer,
wherein the bag comprises sealed sides formed by sealing the film material,
the functional fillers are enclosed in the bag such that the functional fillers do not escape through the sealed sides of the bag, and
the functional fillers comprise thermal insulation particles in powder form (e.g. FF1). With reference to table 1, it should be appreciated that other combinations of inorganic fiber layer layered over the polymer layer can be:
a) FML1, FML2 or FML3 as polymer layer in contact with the FF4 as inorganic fiber layer;
b) FML1 or FML2 as an inorganic fiber layer in contact with FML2 or FML1 as polymer layer respectively;
c) FML1 as an inorganic fiber layer in contact with FML3 as polymer layer (FML2 is not present in this case), etc.

Note that “layered over” could mean that the inorganic fiber layer is on top of the polymer layer or the polymer layer is on top of the inorganic fiber layer.

The film material (e.g. 300a) may comprise:
a cover layer (e.g. FML1, 201, 301) layered over the inorganic fiber layer such that the inorganic fiber layer is between the cover layer and the polymer layer, wherein the cover layer is a polycarbonate (PC) film, polyimide (PI) film, a polyethylene terephthalate (PET) film, a cyclic olefin polymer (COP) film, a casting polypropylene (CPP) film, or a nylon film.

The cover layer may be mixed with the inorganic fiber layer such that there is no clear boundary between the inorganic fiber layer and the cover layer.

Alternatively, the film material may comprise:
a cover layer (e.g. FML1 101) layered over the inorganic fiber layer such that the inorganic fiber layer is between the cover layer and the polymer layer,
wherein the cover layer is a woven ceramic fiber textile.

The film material may comprise:
an innermost layer (e.g. FF4 114),
wherein the polymer layer is layered over the innermost layer,
wherein the innermost layer is in contact with the functional fillers and the innermost layer is made of
at least one of glass fiber, silica wool, mineral wool, ceramic wool, a woven fiber textile, and non-woven fiber textile.

The innermost layer (e.g. FF4 114) may be a glass fiber veil bound by acrylic resin.

The inorganic fiber layer may be woven.

The inorganic fiber layer may be glass fiber woven textile and the glass fiber may be E-glass fiber.

The polymer layer may be made of polycarbonate (PC), Polyethylene (PE), polypropylene (PP), or polyvinyl chloride (PVC); or a composite comprising: PC, PE, PP and/or PVC; and a flame retardant.

The functional fillers may comprise:
at least one of aerogel powder, fumed silica, and glass bubbles; and
at least one of titanium dioxide (TiO2), iron oxide (Fe2O3), and aluminum oxide (Al2O3).

The functional fillers may further comprise:
at least one of magnesium hydroxide (MDH), aluminium hydroxide (ATH), zinc borate, aluminium polyphosphate, and melamine cyanurate.

The polymer layer (e.g. 313) may be mixed with the inorganic fiber layer (e.g. 312) such that there is no clear boundary between the inorganic fiber layer and the polymer layer (e.g. 300b).

The two or more layers of the film material may be attached to one another through adhesive (e.g. 350).

The bag (e.g. 600, 1100, 1170, 1500, 1510, 1520, 1530) may comprise only three sealed sides comprising one straight center seal (e.g. 660, 1504, 1514, 1524, 1534) and two straight side seals (e.g. 663, 665, 1502, 1506, 1512, 1516, 1522, 1526, 1532, 1536), wherein the center straight seal is orthogonal to the two side straight seals.

The bag (e.g. 500) may comprise only four sealed sides (e.g. 570).

Corners of the bag (e.g. 780) may be folded to prevent the functional fillers from escaping through the corners. (e.g. the pre-flapping illustrated in FIGS. 7a-b)

The sealed sides of the bag (e.g. 700) may be folded and attached to a main body of the bag to prevent the functional fillers from escaping through the sealed sides of the bag. (e.g. the flapping illustrated in FIGS. 8a-b)

The film material may comprise a plurality of perforations (e.g. 210, 410), wherein the perforations and the functional fillers are sized such that the functional fillers do not escape through the perforations.

The bag may be degassed to compact the functional fillers enclosed in the bag.

The thermal insulation device (e.g. 1010, 1020, 1030) may comprise one or more intumescent fire-retardant coatings applied on one or two major surfaces of the bag.

The thermal insulation device (e.g. 1000, 1200) may comprise one or more intumescent fire-retardant sheets attached to one or two major surfaces of the bag.

The thermal insulation device (e.g. 1020) may comprise:
two of the bag; and
one or more intumescent fire-retardant sheets disposed between the two bags.

The intumescent fire-retardant sheet (e.g. the Fire-retardant device) may be a non-woven glass fiber mat coated or impregnated with a polymeric or inorganic intumescent solution.

The thermal insulation device may comprise a frame structure (e.g. 1180, 1204, 1304) disposed around a perimeter of the thermal insulation device.

The thermal insulation device the frame structure may be made of silicone.

The frame structure (e.g. 1204, 1304) may comprise:
a first frame layer attached over a first side of the thermal insulation device; and
a second frame layer attached on a second side of the thermal insulation device that is opposite to the first side of the thermal insulation device.

The frame structure may be a single piece frame structure (e.g. 1180).

The thermal insulation device may comprise one or more sheets of electrically insulating film material (e.g. 1206, 1306, 1190) for sealing one or more external major surfaces of the thermal insulation device respectively.

The thermal insulation device may comprise tape and/or adhesive (e.g. 908a, 910a, 912a, 914a, and 914b) applied over one or more external surfaces of the thermal insulation device and a release liner is provided on the tape and/or adhesive to enable the thermal insulation device to be adhered to another object as required. Examples are 908, 910, 912, and 914 in FIGS. 9a-d.

The functional fillers may be non-matrix. They are non-matrix in the sense that there is no network forming, no crosslinking with binder, and/or no structural reinforcing materials present in the functional fillers. In this case, the functional fillers are different from the aerogel blanket discussed in the background section of the present disclosure.

A battery may comprise the thermal insulation device.

In the present disclosure, unless the context clearly indicates otherwise, the term “comprising” has the non-exclusive meaning of the word, in the sense of “including at least” rather than the exclusive meaning in the sense of “consisting only of”. The same applies with corresponding grammatical changes to other forms of the word such as “comprise”, “comprises” and so on.

While the invention has been described in the present disclosure in connection with a number of examples, embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A thermal insulation device comprising: functional fillers enclosed in a bag, wherein the bag is made of a film material comprising at least:
an inorganic fiber layer; and
a polymer layer,
wherein the inorganic fiber layer is layered over the polymer layer;
wherein
the polymer layer is in contact with the functional fillers or
the polymer layer is layered over an innermost layer that is in contact with the functional fillers,
wherein the innermost layer is made of at least one of glass fiber, silica wool, mineral wool, ceramic wool, a woven fiber textile, and non-woven fiber textile;
wherein the bag comprises sealed sides formed by sealing the film material,
the functional fillers are enclosed in the bag such that the functional fillers do not escape through the sealed sides of the bag, and
the functional fillers comprise thermal insulation particles in powder form.

2. The thermal insulation device of claim 1, wherein the film material comprises:
a cover layer layered over the inorganic fiber layer such that the inorganic fiber layer is between the cover layer and the polymer layer,
wherein the cover layer is a polycarbonate (PC) film, polyimide (PI) film, a polyethylene terephthalate (PET) film, a cyclic olefin polymer (COP) film, a casting polypropylene (CPP) film, or a nylon film.

3. The thermal insulation device of claim 2, wherein the cover layer is mixed with the inorganic fiber layer such that there is no clear boundary between the inorganic fiber layer and the cover layer.

4. The thermal insulation device of claim 1, wherein the film material comprises:
a cover layer layered over the inorganic fiber layer such that the inorganic fiber layer is between the cover layer and the polymer layer,
wherein the cover layer is a woven inorganic fiber textile.

5. The thermal insulation device of claim 1, wherein the innermost layer is a glass fiber veil bound by acrylic resin.

6. The thermal insulation device of claim 1, wherein the inorganic fiber layer is woven.

7. The thermal insulation device of claim 6, wherein the inorganic fiber layer is a glass fiber woven textile and the glass fiber is E-glass fiber.

8. The thermal insulation device of claim 1, wherein
the polymer layer is made of polycarbonate (PC), Polyethylene (PE), polypropylene (PP), or polyvinyl chloride (PVC); or
a composite comprising: PC, PE, PP and/or PVC; and a flame retardant.

9. The thermal insulation device of claim 1, wherein the functional fillers comprise:
at least one of aerogel powder, fumed silica, and glass bubbles; and
at least one of titanium dioxide (TiO2), iron oxide (Fe2O3), and aluminum oxide (Al2O3).

10. The thermal insulation device of claim 9, wherein the functional fillers further comprise:
at least one of magnesium hydroxide (MDH), aluminium hydroxide (ATH), zinc borate, aluminium polyphosphate, and melamine cyanurate.

11. The thermal insulation device of claim 1, wherein the polymer layer is mixed with the inorganic fiber layer such that there is no clear boundary between the inorganic fiber layer and the polymer layer.

12. The thermal insulation device of claim 1, wherein two or more layers of the film material are attached to one another through adhesive.

13. The thermal insulation device of claim 1, wherein the bag comprises only three sealed sides comprising one straight center seal and two straight side seals, wherein the center straight seal is orthogonal to the two side straight seals.

14. The thermal insulation device of claim 1, wherein the bag comprises only four sealed sides.

15. The thermal insulation device of claim 1, wherein corners of the bag are folded to prevent the thermal insulation particles from escaping through the corners.

16. The thermal insulation device of claim 1, wherein the sealed sides of the bag are folded and attached to a main body of the bag to prevent the functional fillers from escaping through the sealed sides of the bag.

17. The thermal insulation device of claim 1, wherein the film material comprises a plurality of perforations, wherein the perforations and the functional fillers are sized such that the functional fillers do not escape through the perforations.

18. The thermal insulation device of claim 1, wherein the bag is degassed to compact the functional fillers enclosed in the bag.

19. The thermal insulation device of claim 1, the thermal insulation device comprises one or more intumescent fire-retardant coatings applied on one or two major surfaces of the bag.

20. The thermal insulation device of claim 1, wherein the thermal insulation device comprises one or more intumescent fire-retardant sheets attached to one or two major surfaces of the bag.

21. The thermal insulation device of claim 1, wherein the thermal insulation device comprises:
two of the bag; and
one or more intumescent fire-retardant sheets disposed between the two bags.

22. The thermal insulation device of claim 20, wherein the intumescent fire-retardant sheet is a non-woven glass fiber mat coated or impregnated with a polymeric or inorganic intumescent solution.

23. The thermal insulation device of claim 1, wherein the thermal insulation device comprises a frame structure disposed around a perimeter of the thermal insulation device.

24. The thermal insulation device of claim 23, wherein the frame structure is made of silicone.

25. The thermal insulation device of claim 23, wherein the frame structure comprises:
a first frame layer attached over a first side of the thermal insulation device; and
a second frame layer attached on a second side of the thermal insulation device that is opposite to the first side of the thermal insulation device.

26. The thermal insulation device of claim 23, wherein the frame structure is a single piece frame structure.

27. The thermal insulation device of claim 19, wherein the thermal insulation device comprises one or more sheets of electrically insulating film material for sealing one or more external major surfaces of the thermal insulation device respectively.

28. The thermal insulation device of claim 1, wherein the thermal insulation device comprises tape and/or adhesive applied over one or more external surfaces of the thermal insulation device and a release liner is provided on the tape and/or adhesive to enable the thermal insulation device to be adhered to another object as required.

29. The thermal insulation device of claim 1, wherein the functional fillers are non-matrix.

30. A battery comprising the thermal insulation device of claim 1.
